(19) United States
(12) Patent Application Publication
(10) Pub. No.: US 2025/0028314 A1
(43) Pub. Date: Jan. 23, 2025

(54) INTEGRATED DIGITAL FACTORY AND MAINTENANCE SYSTEM

(71) Applicant: Schlumberger Technology Corporation, Sugar Land, TX (US)

(72) Inventors: Maleek Misbah, Clamart (FR); Jun Wei Xu, Klang (MY)

(21) Appl. No.: 18/777,690

(22) Filed: Jul. 19, 2024

Related U.S. Application Data
(60) Provisional application No. 63/514,415, filed on Jul. 19, 2023.

(51) Int. Cl. G05B 23/02

(52) U.S. Cl. CPC G05B 23/0283; G05B 23/0264

(57) ABSTRACT

Systems and methods for maintaining wellsite equipment are presented herein. For example, an integrated digital factory and maintenance system is configured to receive data relating to maintenance tasks for wellsite equipment at a maintenance shop in substantially real-time during performance of the maintenance tasks; to calculate a plurality of yield metrics, each yield metric of the plurality of yield metrics corresponding to respective maintenance stages of the maintenance tasks in substantially real-time during performance of the maintenance tasks; and to provide the plurality of yield metrics via a graphical user interface displayable via a display device. In addition, the integrated digital factory and maintenance system is configured to calculate a predicted turnaround time for the maintenance tasks based on the plurality of yield metrics; and to provide the predicted turnaround time via the graphical user interface.

### CROSS-REFERENCE TO RELATED APPLICATION

This application claims priority to and the benefit of U.S. Provisional Patent Application Ser. No. 63/514,415, entitled “Integrated Digital Factory and Maintenance System,” filed Jul. 19, 2023, which is hereby incorporated by reference in its entirety for all purposes.

### BACKGROUND

The present disclosure generally relates to systems and methods for maintaining wellsite equipment such as oilfield surface equipment, downhole assemblies, coiled tubing (CT) assemblies, slickline and associated assemblies, and so forth.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Well stimulation is a particular type of well intervention performed on an oil or gas well to increase production by improving the flow of hydrocarbons from the reservoir into the well bore. The profitability of the business is highly dependent on the operation's efficiency. One of the decisive factors of operational efficiency is the well stimulation surface equipment availability. Thus, the maintenance productivity to minimize the surface equipment maintenance turnaround time is a relatively important requirement of the well stimulation business profitability. The turnaround time is a standard metric for monitoring equipment maintenance productivity. Turnaround time may be calculated as the time from when a piece of equipment that requires maintenance arrives in a maintenance base until it is shipped back to operation (e.g., with a fully maintained status). It remains desirable to provide improvements in oilfield surface equipment maintenance for the purpose of effective and efficient use of the oilfield equipment for the provision of oilfield services such as well stimulation and so forth.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method includes monitoring data relating to maintenance tasks for wellsite equipment at a maintenance shop in substantially real-time during performance of the maintenance tasks. The method also includes calculating a plurality of yield metrics, each yield metric of the plurality of yield metrics corresponding to respective maintenance stages of the maintenance tasks in substantially real-time during performance of the maintenance tasks. The method further includes providing the plurality of yield metrics via a graphical user interface displayable via a display device.

In another non-limiting embodiment, an integrated digital factory and maintenance system includes one or more maintenance analysis systems comprising one or more processors configured to execute processor-executable instructions stored on storage media of the one or more maintenance analysis systems. The processor-executable instructions, when executed by the one or more processors, cause the one or more maintenance analysis systems to receive data relating to maintenance tasks for wellsite equipment at a maintenance shop in substantially real-time during performance of the maintenance tasks; to calculate a plurality of yield metrics, each yield metric of the plurality of yield metrics corresponding to respective maintenance stages of the maintenance tasks in substantially real-time during performance of the maintenance tasks; and to provide the plurality of yield metrics via a graphical user interface displayable via a display device.

In yet another non-limiting embodiment, a method includes monitoring data relating to maintenance tasks for wellsite equipment at a maintenance shop in substantially real-time during performance of the maintenance tasks. The method also includes calculating a plurality of yield metrics, each yield metric of the plurality of yield metrics corresponding to respective maintenance stages of the maintenance tasks in substantially real-time during performance of the maintenance tasks. The method further includes calculating a predicted turnaround time for the maintenance tasks based on the plurality of yield metrics. In addition, the method includes providing the plurality of yield metrics and the predicted turnaround time for the maintenance tasks via a graphical user interface displayable via a display device.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates an example well intervention surface equipment maintenance workshop showing eight maintenance steps into which total equipment maintenance turnaround time may be categorized, in accordance with embodiments of the present disclosure;

FIG. 2 illustrates four yields that may be calculated to measure integrity between four maintenance stages, in accordance with embodiments of the present disclosure;

FIG. 3 illustrates a graphical user interface that may be generated by an integrated digital factory and maintenance system, in accordance with embodiments of the present disclosure;

FIG. 4 is a schematic diagram of example components of an integrated digital factory and maintenance system, in accordance with embodiments of the present disclosure;

FIG. 5 illustrates various business systems that may provide data to the integrated digital factory and maintenance system of FIG. 4 to enable the integrated digital factory and maintenance system to perform the maintenance analysis functions described herein, in accordance with embodiments of the present disclosure; and

FIG. 6 is a flow diagram of a method of utilizing the integrated digital factory and maintenance system of FIG. 4, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Asset performance management (APM) is a process that leverages digital technologies and advanced analytics to enable increases in asset availability, reliability, and cost of service delivery for oilfield equipment undergoing maintenance. APM advantageously provides a unified platform where maintenance managers, maintenance supervisors, maintenance engineers and reliability engineers have digital visibility into the entire workflow of the assets after entering a maintenance shop. APM provides real-time asset location in the maintenance base, the asset's maintenance status, the asset's preventative maintenance status, deficiencies reported on the asset, bay availability to perform maintenance in the maintenance shop, current open work orders, parts availability to perform maintenance, current technician assignments, an amount of time each asset spends in a zone in the maintenance base and/or in a particular maintenance bay, time spent by technicians on particular assets, how many assets have moved from a first zone to a second zone and in a correct process flow, among other information. As used herein, the term “asset” may be used to refer to the various pieces of equipment that are maintained at the maintenance workshops described herein.

A maintenance workshop's productivity may be measured by equipment maintenance turnaround time. In a well stimulation surface equipment maintenance workflow, assets deployed to the field in operations come back to the maintenance shop for routine maintenance (i.e., preventive maintenance) or breakdown maintenance (i.e., repair). The turnaround time is the time between the well stimulation surface equipment's arrival in the maintenance workshop and the time when all the maintenance is complete and ready for the redeployment of the equipment back to operation.

The embodiments described herein implement a “digital factory” concept that maximizes the productivity of a well stimulation surface equipment maintenance workshop by minimizing the average equipment maintenance turnaround time. The embodiments described herein provide an intelligent maintenance productivity management solution with an objective of making minimal maintenance turnaround time a reality by defining four new maintenance yield metrics, establishing a framework to automate the calculation of these maintenance yield metrics digitally by utilizing data that is currently available. In particular, as described in greater detail herein, the embodiments described herein define four maintenance yields of a maintenance workflow, namely: (1) equipment field defect report yield, (2) maintenance pre-QA/QC (pre-quality assurance/quality control), (3) maintenance tasks yield, and (4) maintenance quality yield.

In general, the embodiments described herein utilize two maintenance performance measurements to benchmark maintenance workshop performance, namely, 1) maintenance bottleneck detection, and 2) throughput monitoring. In addition, the embodiments described herein define potential performance metrics at a maintenance performer's level to further improve maintenance performance in a surface equipment maintenance workshop. The embodiments described herein empower a surface equipment maintenance team to execute their maintenance workflows faster and digitally make informed decisions based on the next level of data insights.

The digital factory of the present disclosure uses business system data, camera analytics, and machine learning algorithms to improve both safety and productivity performance within a maintenance workshop. The digital factory enables bottleneck detection and reduces the turnaround time of equipment during the maintenance process while advantageously providing for visibility of the end-to-end asset flow and productivity.

The data utilized by the embodiments described herein to define the metrics and digitally monitor the maintenance workshop's productivity include, for example, a computerized maintenance management system (CMMS), a maintenance tool system, a global positioning system (GPS) data tracking system, real-time equipment monitoring (RTEM) for the well stimulation surface equipment via the GPS devices, camera analytics, and other business system(s).

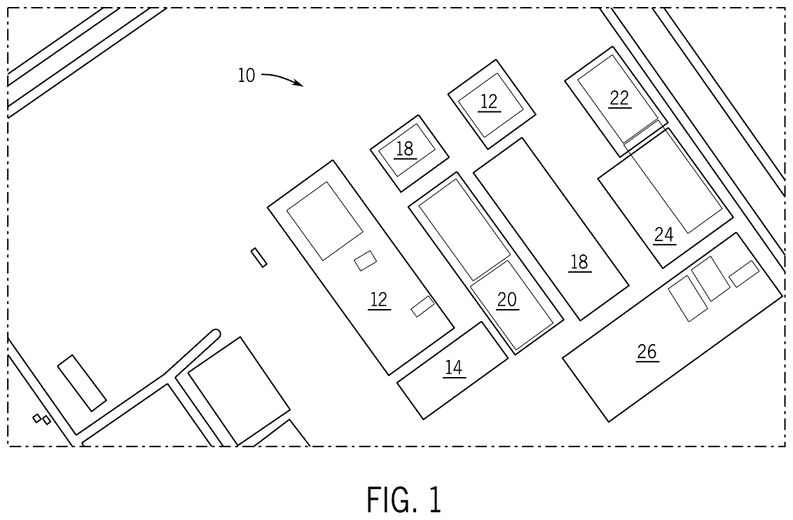

With the foregoing in mind, FIG. 1 illustrates an example well intervention surface equipment maintenance workshop 10 showing eight maintenance steps into which total equipment maintenance turnaround time may be categorized by the digital factory embodiments described herein. As illustrated in FIG. 1, the maintenance workshop 10 may include one or more incoming equipment locations 12 where equipment arrives at the maintenance workshop 10 from an operation site (e.g., field location). In addition, the maintenance workshop 10 may include an equipment cleaning location 14 where the equipment may be cleaned (e.g., washed, and so forth) before maintenance on the equipment is started at the maintenance workshop 10. In addition, the maintenance workshop 10 may include a pre-QA/QC location 16, which is an incoming inspection point where the maintenance and repair that is required for redeployment of the equipment to operations is defined. In addition, the maintenance workshop 10 may include a pre-maintenance holding location 18, where the equipment may be held while waiting for maintenance, and the equipment is clear and ready to start maintenance. In addition, the maintenance workshop 10 may include a maintenance location 20 where essential maintenance of the equipment is performed. In addition, the maintenance workshop 10 may include a QA/QC waiting location 22 where the equipment awaits an operational QA/QC check after maintenance has been performed on the equipment. In addition, the maintenance workshop 10 may include a QA/QC location 24 at which the operational QA/QC check occurs after the maintenance has been performed on the equipment. In addition, the maintenance workshop 10 may include an equipment shipping location 26 where the equipment is staged as ready for redeployment back to the field after maintenance.

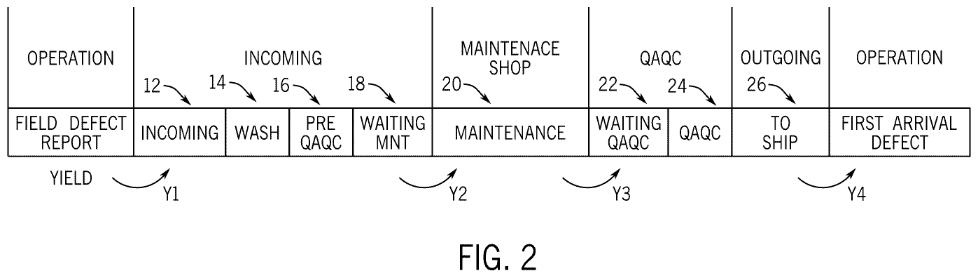

In certain embodiments, the eight types of locations of the maintenance workshop 10 illustrated in FIG. 1 may be clustered into four separate maintenance stages: (1) Incoming—the incoming equipment locations 12, the equipment cleaning location 14, the pre-QA/QC location 16, and the pre-maintenance holding location 18; (2) Shop—the maintenance location 20; (3) QA/QC—the QA/QC waiting location 22 and the QA/QC location 24; and (4) Outgoing—the equipment shipping location 26. As a result, four yields may be calculated to measure the integrity between these four maintenance stages, as also shown in FIG. 2:

Yield 1 (Y1)—Equipment field defect report yield. Y1 defines how many potential issues are reported by the field defect reports from the operation (e.g., field) when the equipment is used versus maintenance tasks later defined by the pre-QA/QC (e.g., shop-initiated tasklines that are in addition to potential tasks initially defined by the field defect reports).

$$Y 1 = \frac{\sum count ( Field Defect Reports )}{\begin{matrix}\sum count ( Field Defect Reports ) + \\ \sum count ( Maintenance tasks defined by Pre - QA / QC )\end{matrix}}$$

Yield 2 (Y2)—Maintenance Pre-QA/QC yield. Y2 defines how many potential issues are reported by the pre-QA/QC versus the actual maintenance tasks performed in the maintenance workshop 10 (e.g., from work orders). In other words, Y2 represents tasks reported during the incoming stage 12 (e.g., that are reported to the pre-QA/QC stage 16) versus tasks captured after the asset flows into the maintenance shop 10 for maintenance (e.g., total count of current task work orders).

$$Y 2 = \frac{\sum count ( Tasks reported at Pre - QA / QC )}{\sum count ( Actual tasks in the shop )}$$

Yield 3 (Y3)—Maintenance tasks yield. Y3 defines how much equipment passes the first time during the operational maintenance inspection after the maintenance. In other words, Y3 is a quality check pass rate for the maintenance workflow.

$$Y 3 = 1 - \frac{\sum count ( Maintenance operational inspection failures )}{\sum count ( Actual tasks in the shop )}$$

Yield 4 (Y4)—Maintenance quality yield. Y4 defines how many pieces of equipment have a first-arrival defect in the field after maintenance. In other words, Y4 is calculated as a count of defects after being delivered back to operations versus a count of defect reports defect reports from the maintenance shop 10 plus a count of tasklines in the maintenance shop 10.

$$Y 4 = \frac{\sum count ( Defects in first service from operation )}{\begin{matrix}\sum count ( Maintenance operational inspection failures ) + \\ \sum count ( Actual tasks in the shop )\end{matrix}}$$

The integrated digital factory and maintenance system described herein may generate a digital layout of a well intervention surface equipment maintenance workshop 10 (e.g., geographic zones) for live measurement (e.g., maintenance bottleneck and weekly throughput performance).

In certain embodiments, a GPS device may be installed on each well intervention surface equipment maintained in the maintenance workshop 10 to identify the physical location of the equipment. During maintenance, the surface equipment may move within the maintenance workshop 10 for anywhere between a few hours and a few days. As such, to capture this level of granularity, the GPS ping frequency may be configured to a 2-hour frequency. In certain embodiments, a web application may be utilized to display the asset's physical location on a map view. In the web application, GeoZones may be provided, defined by a GeoFences configuration (e.g., latitude and longitude of a virtual fence around a particular area in the map view).

In certain embodiments, only one Geozone is defined for the well intervention surface equipment maintenance workshop 10. However, in other embodiments, the integrated digital factory and maintenance system described herein may separate the main GeoZone (e.g., that defines the maintenance workshop 10 itself) into eight new GeoZones in the web application with new GeoFences, corresponding with the eight maintenance locations illustrated in FIG. 1, and connect multiple GeoZones into the four maintenance stages described above to enable automatic and continuous yield monitoring.

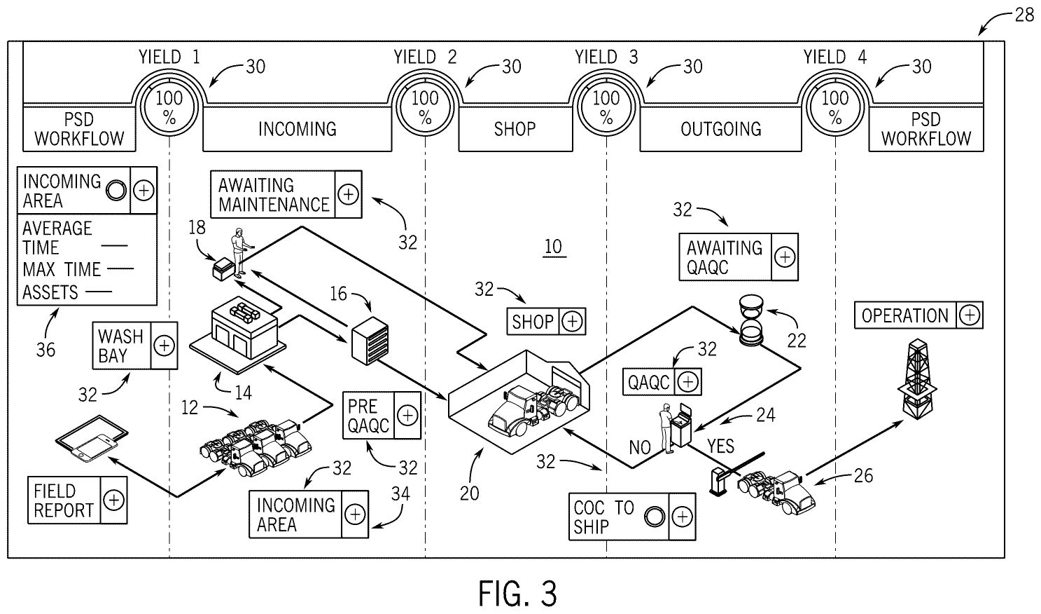

The integrated digital factory and maintenance system described herein advantageously provides a way to monitor or compare a particular surface equipment's position information or change to decide its maintenance step/stage status. This approach includes two automatic performance-measuring models (e.g., a maintenance bottleneck detection model and a throughput performance monitoring model), together with the four calculated yields Y1-Y4. FIG. 3 illustrates a graphical user interface 28 that may be generated by the integrated digital factory and maintenance system described herein and provided for display on a display device. As illustrated, the graphical user interface 28 may display visual representations of the various locations of a maintenance workshop 10, which are illustrated in FIG. 1, along with graphical representations 30 (e.g., numerical values along with a visual scale, in the illustrated embodiment) of the yields Y1-Y4 for the four respective maintenance stages and two maintenance performance measurements (e.g., from the maintenance bottleneck detection model and the throughput performance monitoring model) described herein. In addition, in certain embodiments, the graphical user interface 28 may display title blocks 32 of each of the various maintenance locations of the maintenance workshop 10 proximate the respective visual representations of the maintenance locations, each title block 32 including an icon 34 (e.g. a +symbol in the illustrated embodiment) that, when selected by a user, cause a summary table 36 of pertinent information for that maintenance location including, but not limited to, average time for assets at the particular maintenance location, maximum time for an asset at the particular maintenance location, number of assets that have passed through the particular maintenance location for a given period of time (e.g., a week), and so forth.

### Maintenance Bottleneck Detection Model

The maintenance bottleneck detection model compares position data for a particular piece of equipment between two pings to identify the idle time (days at zones), which is defined as the duration of stay of an asset in a particular zone (e.g., as “Days at Zone”). It is calculated based on an initial time stamp and the next time stamp of the asset detection at specific GeoZones. Days at Zone indicate the idle time of the equipment at a specific maintenance step so that the maintenance team can address potential problems with proper digital insight. The highest average maintenance step with the most significant numerical Days at Zones may be defined as the maintenance bottleneck detection model from the integrated digital factory and maintenance system described herein.

### Throughput Performance Monitoring Model

Throughput refers to how much equipment can be maintained by a system within a given timeframe. Throughput may generally be considered the count of the surface equipment maintained every week. The integrated digital factory and maintenance system described herein advantageously counts the number of assets moved from one zone to another zone to be the respective maintenance step's throughput. The throughput performance monitoring model practically captures the position change between two pings to determine the weekly throughput performance for each maintenance step. The throughput performance monitoring model defines the performance level of the weekly throughput as below and integrates the performance benchmark with the four maintenance stage's yields:
Exceeds Expectations (green color coding): >a weekly throughput objective, normalized to the day count.
Meets Expectations (yellow color coding): >80% of the weekly throughput objective, normalized to the day count.
Attention Needed (red color coding): between 50% to 80% of the weekly throughput objective, normalized to the day count.

Other optional potential performance metrics at a maintenance performer's level may also be used to improve maintenance performance further in a surface equipment maintenance workshop 10. For example, the metrics listed below, if available, potentially from video camera analytics, may optionally be integrated into the integrated digital factory and maintenance system described herein to further improve the productivity of the surface equipment maintenance workshop 10.
Maintenance Bay Utilization Metric—the percentage of surface equipment maintenance space occupied by assets for a given period of time (e.g., for a week).
Effective Capacity Metric—the percentage of time that maintenance work is performed on surface equipment out of the total time spent by a maintenance technician in the bay for a given period of time (e.g., for a week). Effective capacity may be monitored by distance detection from a particular technician to the surface equipment by video analytics.
People Count Metric—the total number of technicians working in a given period of time (e.g., for a week).

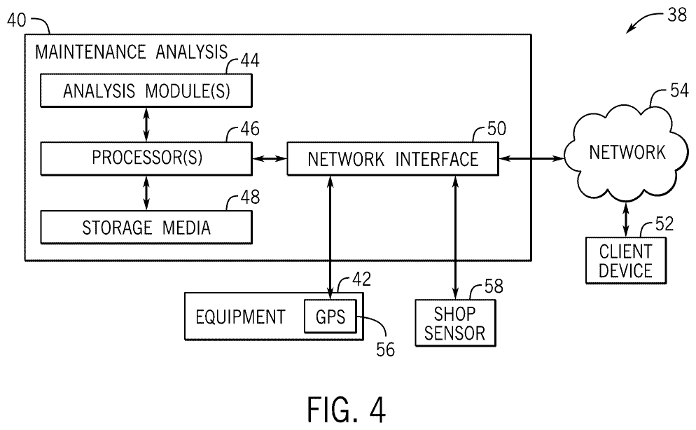

FIG. 4 is a schematic diagram of example components of the integrated digital factory and maintenance system 38 described herein. For example, the integrated digital factory and maintenance system 38 may include one or more maintenance analysis systems 40 that may be used to receive data relating to the maintenance of various pieces of equipment 42 at a maintenance shop 10 over time. In certain embodiments, the maintenance analysis system(s) 40 may each include one or more analysis modules 44 (e.g., computer-executable instructions and associated data) that may be configured to perform various functions of the embodiments described herein. For example, the analysis modules 44 of the maintenance analysis system(s) 40 may be configured to determine calculate turnaround times for maintenance of the equipment 42 at a maintenance workshop 10, as described in greater detail herein.

In certain embodiments, to perform these various functions, the one or more analysis modules 44 may execute on one or more processors 46 of the maintenance analysis system(s) 40, which may be connected to one or more storage media 48 of the maintenance analysis system(s) 40. Indeed, in certain embodiments, the one or more analysis modules 44 may be stored in the one or more storage media 48. In certain embodiments, the computer-executable instructions of the one or more analysis modules 44, when executed by the one or more processors 46, may cause the one or more processors 46 to perform the maintenance analysis techniques described in greater detail herein. In certain embodiments, the analysis modules 44 that enable the embodiments described herein may run locally (e.g., on a local computer), as a cloud-based solution, or as a plugin to existing software.

In certain embodiments, the one or more processors 46 may include a microprocessor, a microcontroller, a processor module or subsystem, a programmable integrated circuit, a programmable gate array, a digital signal processor (DSP), or another control or computing device. In certain embodiments, the one or more processors 46 may include machine learning and/or artificial intelligence (AI) based processors that, for example, enable the one or more processors 46 to analyze maintenance tasks performed at a maintenance shop 10, as described in greater detail herein. In certain embodiments, the one or more storage media 48 may be implemented as one or more non-transitory computer-readable or machine-readable storage media. In certain embodiments, the one or more storage media 48 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

It should be noted that the computer-executable instructions and associated data of the analysis module(s) 44 may be provided on one computer-readable or machine-readable storage medium of the storage media 48, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 48 may be located either in the machine running the machine-readable instructions, or may be located at a remote site from which machine-readable instructions may be downloaded over a network for execution.

In addition, in certain embodiments, the processor(s) 46 may be connected to a network interface 50 of the maintenance analysis system(s) 40 to allow the maintenance analysis system(s) 40 to, for example, communicate with various client devices 52 via a network 54 for the purpose of providing various graphical user interfaces 28 via display devices of the client devices 52, as described in greater detail herein. In addition, the network interface 50 of the maintenance analysis system(s) 40 may enable the maintenance analysis system(s) 40 to receive data from various sensors associated with the maintenance shop 10 and/or the various pieces of equipment 42 for which maintenance is performed at the maintenance shop 10.

For example, as described in greater detail herein, the pieces of equipment 42 may be associated with GPS tracking systems 56 that enable collection of GPS data for the equipment 42 while the equipment moves about the various locations of the maintenance shop 10. In certain embodiments, the GPS tracking systems 56 may be affixed to the pieces of equipment 42 while the pieces of equipment 42 are received at the incoming equipment locations 12 and removed from the pieces of equipment 42 when the pieces of equipment 42 are waiting to be shipped back to operation (e.g., the field) at the equipment shipping locations 26.

In addition, as also described in greater detail herein, various maintenance shop sensors 58 may be located around the maintenance shop 10 such that various types of data may be collected relating to the maintenance shop 10 over time. For example, in certain embodiments, the maintenance shop sensors 58 may include cameras configured to collected images and/or video of operations occurring at the various locations of the maintenance shop 10 such that the collected images and/or video may be used to determine various operational metrics of the maintenance shop 10, as described in greater detail herein.

It should be appreciated that the integrated digital factory and maintenance system 38 illustrated in FIG. 4 is only one example of an integrated digital factory and maintenance system, and that the integrated digital factory and maintenance system 38 may have more or fewer components than shown, may combine additional components not depicted in the embodiment of FIG. 4, and/or the integrated digital factory and maintenance system 38 may have a different configuration or arrangement of the components depicted in FIG. 4. In addition, the various components illustrated in FIG. 4 may be implemented in hardware, software, or a combination of both hardware and software, including one or more signal processing and/or application specific integrated circuits. Furthermore, the operations of the integrated digital factory and maintenance system 38 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

The integrated digital factory and maintenance system 38 illustrated in FIG. 4 provides a digital workplace that uses business system data, camera analytics, and machine learning algorithms to collectively enhance safety and productivity in maintenance workshops 10. Digital workshops, such as the one illustrated in FIG. 3, may be deployed to support an organization with safety and maintenance efficiency improvements, meeting the demands of the operations. The digital workshops enable bottleneck detection and reduce the turnaround time of equipment 42 during the maintenance process. This provides visibility of the end-to-end asset flow and productivity.

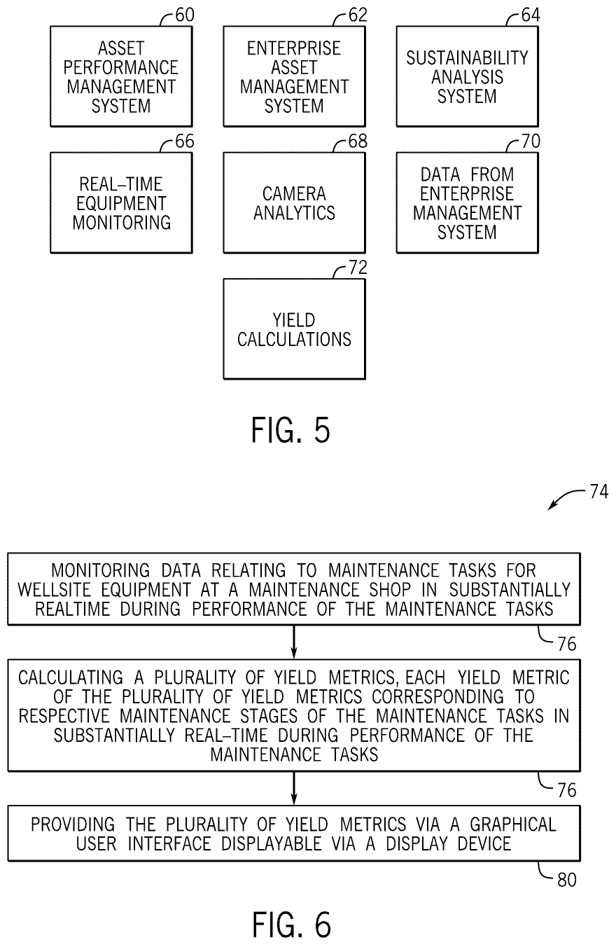

Data from various business systems may be utilized by the integrated digital factory and maintenance system 38 described herein, such as those illustrated in FIG. 5. As illustrated in FIG. 5, such business systems may include an APM system 60 (e.g., Maximo, and so forth), an enterprise asset management system 62 (e.g., MTEcosystem, and so forth), a sustainability analysis system 64 (e.g., Blue World, and so forth), real-time equipment monitoring (RTEM) 66, camera analytics 68, and data from an enterprise management system 70 (e.g., SAP, and so forth). The data from these various business systems may be utilized by the integrated digital factory and maintenance system 38 described herein to perform the yield calculations 72 described in greater detail herein. The data from these various business systems may be tailored in a way to measure asset productivity performance in a maintenance workshop 10. The idea behind APM is to have a unified platform where maintenance managers, maintenance supervisors, maintenance engineers and reliability engineers, and so forth, may see the entire workflow of the assets after entering the maintenance shop 10 digitally with real-time asset location in the maintenance shop 10, its maintenance status, PM status, asset status, deficiencies reported on the asset, bay availability to perform maintenance in the maintenance shop 10, open work orders, parts availability to perform maintenance, technician assignments, time each asset spends in a zone in the maintenance shop 10 and in a particular maintenance bay, time spent by technicians on the assets, how many assets have moved from one zone to the next and in a correct process flow, among other things.

As per the standard asset workflow, assets which are deployed to the field in operations come back to the maintenance shop 10 for routine maintenance (i.e., preventive maintenance) or breakdown maintenance. Once assets are back in the shop and again ready to dispatch back into the field, the entire workflow including the zones assets have passed through, the sequence of asset flow in the various zones, duration of stay in each zone, and so forth, have heretofore been unknown, needing to be captured manually. The digital factory concept described herein brings all of this granularity on a single platform.

### APM System

Near real-time data from an APM system 60 may be captured using application programming interface (API) connections to be displayed in an APM workflow of a particular asset at various stages. The below information may be available in the APM system 60 on a list view page and on a maintenance shop detailed view screen and additional resources (e.g., as illustrated in the example graphical user interface 28 illustrated in FIG. 3).

Work Order Number—For every asset, when being worked on for a repair task or preventive maintenance, a work order is opened and data is captured in a structured format with all the labor, parts, and work details. A parent work order (e.g., repair type) is opened, which is on top of the hierarchy and has all the child work orders like DRs (deficiency reports—reported at the maintenance shop 10 most often and, in some cases, in the field to capture the fault details), FRs (field repairs—reports captured in the field for the faults and acted upon in the field), FCOs (field change orders—maintenance bulletin work orders), and so forth.

Tasklines—Reports added by technicians or the QA/QC team in addition to DRs and FRs to capture the details of failure and the tasks performed by them. Specific tasks with standard job codes like PITDEF, TESTPIT, PRETEST, and so forth, may be used to add the work inside a parent work order at various stages of asset maintenance.

Work Order Creation Date—This is the information about the date when a certain work order was created. This gives a quick reference to the maintenance supervisors (MSVs) to check when the work was started on the asset.

Work Order Status—The status of each child work order and the parent work order defines the asset maintenance status and the supervisors need to know the current status. Also, the asset location in the maintenance shop 10 in various zones needs to match the work order status. For example, if an asset is red-tagged in the APM system 60, it is supposed to be in a red-tagged area (e.g., a dedicated geozone for red-tagged assets). Similarly, if an asset is in a green zone, all the work orders should include a completed status (e.g., WORKCOMP or COMP).

Meter—An updated meter reading of a primary meter associated with the asset (e.g., runhour or hub mile) may be pulled from the database to display here. This gives a quick reference to the technology lifecycle management (TLM) team about asset life and the same reading may be used in a CMMS to update the work order status.

Asset Status—Active, idle, stacked, out of service, and decommissioned status of the asset from the APM system 60.

Maintenance Status—Green, red, and yellow tag information of assets. If the work orders are in progress, then the maintenance status of the asset is red in the CMMS (e.g., an APM system 60) and cannot be deployed to the field for operations.

PM Indicator—Information from the APM system 60 on the preventive maintenance status, whether green or red, as per the ongoing maintenance work and the work order status.

Child Work Order—Child work orders are the deficiency reports (DRs), field repairs (FRs), field change orders (FCOs), tasklines, and so forth.

Preventive Maintenance (PM)—PM assigned to the asset, last completion date, its frequency, and units to go information.

Maintenance Event Ongoing—Description of the parent work order mentioned in the APM system 60.

Promise Date—The date mentioned in the parent work order for the completion of the task.

Red Tag DR—This displays the deficiencies reported in the APM system 60 on an asset, which are red-tagged and making the asset non-operational.

Yield—The calculation is yield from the above work order types at the various geozones as per the asset process flow, as described in greater detail herein.

### Enterprise Asset Management System

Assigned Technicians-Assets when maintained in the maintenance shop 10 may have a parent work order opened to be worked on and the technicians intended to work on the asset to carry out maintenance tasks may be added in the parent work order through a maintenance shop application ‘MT Shop’ of the enterprise asset management system 62, for example.

Field Repairs (FRs)—Reports captured in the field for faults and acted upon at in field using an ‘MT Point’ application in the field location.

Deficiency Report (DR)—reported at the maintenance shop 10 mostly and in some cases at the field to capture the fault details.

Meter—An updated meter reading of the primary meter of the asset (e.g., runhour or hub mile) may be retrieved from the database to display here. This gives a quick reference to the TLM team about asset life and the same reading may be updated by the team in the field using a ‘Miles and Hours’ MT application, for example.

### Sustainability Analysis System

Web Application—A web application may be used to primarily display the asset's physical location within a maintenance shop 10 on a map view, for example, as illustrated in FIG. 3.

Geofencing—Geofencing is a virtual fence around a certain area in the map view (e.g., illustrated in FIG. 3) to differentiate the selected area from the others.

Geozone—Geofencing creates a defined area that can be named to facilitate the use of certain places as per the process workflow. For example, a wash bay 14 is a particular geozone, and the maintenance shop 10 in general is another geozone.

The geofencing is done to create the desired geozones in the maintenance shop 10 from an idle value stream mapping of equipment flow in the step-by-step process.

GPS Devices—As described herein, a GPS device 56 may be used to identify the physical location of a particular asset within the maintenance shop 10. To do so, the GPS devices 56 may be installed on the assets to be used to share the real-time position of the assets, for example, with a satellite. By default, the satellite ping frequency of these GPS devices 56 may be set to two pings in a day while stationary and one ping per hour during motion. This configuration may not be suitable to capture the accurate asset location and its movement between the geo zones in the maintenance workflow where assets are moving sometimes in a couple of hours to a few days. To capture this level of granularity, the GPS ping frequency may be changed to ping every two hours.

Days at Zone—The duration of stay of an asset in a particular zone is ‘Days at Zone’. It may be calculated based on the initial time stamp and the next time stamp of the asset detection at the specific geozone.

Throughput—Throughput refers to how much equipment 42 can be processed/maintained by a system within a given timeframe. Throughput=Units Processed/Time. It is based on the number of assets moved from one zone to another zone. If the number is 2, it means that there are two assets physically moved from one zone to another zone. Here, the number of days it takes for an asset to complete maintenance is captured, and most of this data comes from a CMMS system (e.g., the APM system 60) and/or the sustainability analysis system 64.

Absolute Throughput—This refers to the number of assets moved out of one particular zone to any other zone (or outside the zones, i.e. to the field locations).

Actual Throughput—This refers to the number of assets moved out of a selected zone as per the process flow displayed in the Map view (e.g., illustrated in FIG. 3). Identification of asset movement (i.e., Throughput) in the right direction of flow is relatively important to ascertain adherence to the process flow of assets in the maintenance shop 10. A compliance score may be generated for the assets moving in the correct direction as per the process map view.

Asset Scanning—An alternative way to locate assets in the map view is by scanning an asset identification QR code (e.g., that is affixed to the equipment 42) and the same information may be synchronized back to the sustainability analysis system 64 immediately to show the scanned asset location in the map view.

### RTEM (Real-Time Equipment Monitoring)

GPS Enabled Assets—The system described herein provides for traceability of all GPS assigned to the assets. The digital factory works on the concept of automatic asset traceability, so as to eliminate assets from the list view that are manually scanned and not contributing to real-time productivity. In other words, those manually tracked assets may be filtered out.

### Camera Analytics

Cameras (e.g., as part of the shop sensors 58) may be installed in the maintenance shop 10 to be used to capture live monitoring of all the workshop bays, recording videos and providing hourly photos of all of the bays. The key performance indicators (KPIs) defined below may be measured by applying camera analytics and logic to the data captured by the cameras.
Total Bay Utilization: Percentage of workshop space occupied by assets for a current week.
Effective Capacity: Percentage of time work is done on an asset, out of the total time spent by the asset in a bay for the current week.
Throughput: Total number of unique assets worked upon in a current week.
People Count: Total number of technicians working in a current week
Total Bay Utilization: Percentage of time a particular bay is occupied by assets for a current week.
Effective Capacity: Percentage of time work is done on an asset in a bay, out of the total time spent by the asset in the bay for a current week.
Throughput: Total number of unique assets worked upon in a current week from a selected bay.
People Count: Total number of technicians working in a current week at a selected bay.
Asset Number (Live only): This displays an asset number identified from the electronic ID on the particular asset. The electronic ID may be detected by the cameras in a particular bay, then optical character recognition (OCR) may be applied to the detected image and some additional logic may be used to identify the asset number using information in a database of the APM system 60, for example. If the asset number is not identified from the electronic ID or the Electronic ID itself is not found on the asset, an ‘Electronic ID not found’ message may instead be displayed.
Bay: This will show the bay number as per the selection from the workshop model.
Cycle Time: Amount of time an asset stays in a selected bay, as determined by the current assets in the selected bay.
Effective Hours: Actual time technicians have worked on a particular asset.
Maintenance Event Ongoing: Parent Work Order description from the APM system 60 may be displayed in this field.
Effective technician utilization: Actual time technicians have worked on a particular asset, also with a live count of technicians.
   Data from an Enterprise Management System

Work in progress—API connections may be used to capture the most useful information from a database of the enterprise management system 70, for example, about the availability of spare parts to perform routine maintenance tasks in the maintenance shop 10.

The buyer part number (BPN), supplier part number (SPN), and required quantity may be retrieved from the asset Bill of Material (BOM) and, as a result of the query, the stock on hand for the specified BPN and the open purchase order (PO) may be determined, with the quantity on the order.

### Yield Calculations

The yield calculations Y1-Y4 described herein for the four main steps of equipment flow in a maintenance shop 10 may be displayed, with the ability to drill down to Technology and Asset Code. The yield values are dependent on the number of reports and the location of the reports, and the count of deficiencies report (DRs), field reports (FRs), and task lines. All of these terms are terms from the APM system 60 and/or the enterprise asset management system 62. These are the different types of work orders reported under a parent work order to capture different kinds of maintenance events and repair events.

Bottleneck—T3/T4 granularity by Technology and Asset Code to provide visibility for the end user on bottlenecks and lagging assets/workflows. Asset technology type with a granularity up to the level of asset number identified as the bottleneck of each zone. The number here shows the number of days an asset stays in a specific zone. Direct action of aligning the resources to a specific zone can be taken from this data to comply with the mass balance of assets. Turnaround time of assets measured from here for each step of the maintenance process helps to improve the efficiency by targeting the area taking the longest amount of time.

FIG. 6 is a flow diagram of a method 74 of utilizing the integrated digital factory and maintenance system 38 described herein. As illustrated in FIG. 6, the method 74 may include monitoring data relating to maintenance tasks for wellsite equipment 42 at a maintenance shop 10 in substantially real-time during performance of the maintenance tasks (block 76). In addition, the method 74 may include calculating a plurality of yield metrics (Y1-Y4), each yield metric of the plurality of yield metrics (Y1-Y4) corresponding to respective maintenance stages of the maintenance tasks in substantially real-time during performance of the maintenance tasks (block 78). In addition, the method 74 may include providing the plurality of yield metrics (Y1-Y4) via a graphical user interface 28 displayable via a display device (e.g., of a client device 52) (block 80).

In addition, in certain embodiments, the plurality of yield metrics (Y1-Y4) may include a first yield metric (Y1) that defines a relationship between potential issues reported by field defect reports and maintenance tasks identified at a pre-QA/QC location 16 of the maintenance shop 10. In addition, in certain embodiments, the plurality of yield metrics (Y1-Y4) may include a second yield metric (Y2) that defines a relationship between maintenance tasks reported at a pre-QA/QC location 16 of the maintenance shop 10 and actual maintenance tasks being performed at the maintenance shop 10. In addition, in certain embodiments, the plurality of yield metrics (Y1-Y4) may include a third yield metric (Y3) that defines a relationship between maintenance operational inspection failures and actual maintenance tasks being performed at the maintenance shop 10. In addition, in certain embodiments, the plurality of yield metrics (Y1-Y4) may include a fourth yield metric (Y4) that defines a relationship between defects in first service from operation and maintenance operational inspection failures and actual maintenance tasks being performed at the maintenance shop 10.

In addition, in certain embodiments, the method 74 may include calculating a predicted turnaround time for the maintenance tasks based on the plurality of yield metrics (Y1-Y4), and providing the predicted turnaround time via the graphical user interface 28. In addition, in certain embodiments, the method 74 may include providing visual representations of a plurality of maintenance locations 12, 14, 16, 18, 20, 22, 24, 26 of the maintenance shop 10 via the graphical user interface 28. In addition, in certain embodiments, the method 74 may include providing title blocks 32 proximate respective visual representations of the maintenance locations 12, 14, 16, 18, 20, 22, 24, 26 via the graphical user interface 28. In certain embodiments, each title block 32 includes an icon 34 that, when selected by a user via the graphical user interface 28, causes a summary table 36 of information for the respective maintenance location 12, 14, 16, 18, 20, 22, 24, 26 to be provided via the graphical user interface 28.

In addition, in certain embodiments, monitoring the data relating to the maintenance tasks for the wellsite equipment 42 at the maintenance shop 10 includes collecting data from GPS tracking systems 56 associated with respective wellsite equipment 42. In addition, in certain embodiments, monitoring the data relating to the maintenance tasks for the wellsite equipment 42 at the maintenance shop 10 includes collecting data from maintenance shop sensors 58 located around the maintenance shop 10.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

What is claimed is:

1. A method, comprising:
monitoring data relating to maintenance tasks for wellsite equipment at a maintenance shop in substantially real-time during performance of the maintenance tasks;
calculating a plurality of yield metrics, each yield metric of the plurality of yield metrics corresponding to respective maintenance stages of the maintenance tasks in substantially real-time during performance of the maintenance tasks; and
providing the plurality of yield metrics via a graphical user interface displayable via a display device.

2. The method of claim 1, wherein the plurality of yield metrics comprises a first yield metric (Y1) that defines a relationship between potential issues reported by field defect reports and maintenance tasks identified at a pre-quality assurance/quality control location of the maintenance shop.

3. The method of claim 1, wherein the plurality of yield metrics comprises a second yield metric (Y2) that defines a relationship between maintenance tasks reported at a pre-quality assurance/quality control location of the maintenance shop and actual maintenance tasks being performed at the maintenance shop.

4. The method of claim 1, wherein the plurality of yield metrics comprises a third yield metric (Y3) that defines a relationship between maintenance operational inspection failures and actual maintenance tasks being performed at the maintenance shop.

5. The method of claim 1, wherein the plurality of yield metrics comprises a fourth yield metric (Y4) that defines a relationship between defects in first service from operation and maintenance operational inspection failures and actual maintenance tasks being performed at the maintenance shop.

6. The method of claim 1, comprising:
calculating a predicted turnaround time for the maintenance tasks based on the plurality of yield metrics; and
providing the predicted turnaround time via the graphical user interface.

7. The method of claim 1, comprising providing visual representations of a plurality of maintenance locations of the maintenance shop via the graphical user interface.

8. The method of claim 7, comprising providing title blocks proximate respective visual representations of the maintenance locations via the graphical user interface, wherein each title block comprises an icon that, when selected by a user via the graphical user interface, causes a summary table of information for the respective maintenance location to be provided via the graphical user interface.

9. The method of claim 1, wherein monitoring the data relating to the maintenance tasks for the wellsite equipment at the maintenance shop comprises collecting data from global positioning system (GPS) tracking systems associated with respective wellsite equipment.

10. The method of claim 1, wherein monitoring the data relating to the maintenance tasks for the wellsite equipment at the maintenance shop comprises collecting data from maintenance shop sensors located around the maintenance shop.

11. An integrated digital factory and maintenance system, comprising:
one or more maintenance analysis systems comprising one or more processors configured to execute processor-executable instructions stored on storage media of the one or more maintenance analysis systems, wherein the processor-executable instructions, when executed by the one or more processors, cause the one or more maintenance analysis systems to:
receive data relating to maintenance tasks for wellsite equipment at a maintenance shop in substantially real-time during performance of the maintenance tasks;
calculate a plurality of yield metrics, each yield metric of the plurality of yield metrics corresponding to respective maintenance stages of the maintenance tasks in substantially real-time during performance of the maintenance tasks; and
provide the plurality of yield metrics via a graphical user interface displayable via a display device.

12. The integrated digital factory and maintenance system of claim 11, wherein the plurality of yield metrics comprises a first yield metric (Y1) that defines a relationship between potential issues reported by field defect reports and maintenance tasks identified at a pre-quality assurance/quality control location of the maintenance shop.

13. The integrated digital factory and maintenance system of claim 11, wherein the plurality of yield metrics comprises a second yield metric (Y2) that defines a relationship between maintenance tasks reported at a pre-quality assurance/quality control location of the maintenance shop and actual maintenance tasks being performed at the maintenance shop.

14. The integrated digital factory and maintenance system of claim 11, wherein the plurality of yield metrics comprises a third yield metric (Y3) that defines a relationship between maintenance operational inspection failures and actual maintenance tasks being performed at the maintenance shop.

15. The integrated digital factory and maintenance system of claim 11, wherein the plurality of yield metrics comprises a fourth yield metric (Y4) that defines a relationship between defects in first service from operation and maintenance operational inspection failures and actual maintenance tasks being performed at the maintenance shop.

16. The integrated digital factory and maintenance system of claim 11, wherein the processor-executable instructions, when executed by the one or more processors, cause the one or more maintenance analysis systems to:
calculate a predicted turnaround time for the maintenance tasks based on the plurality of yield metrics; and
provide the predicted turnaround time via the graphical user interface.

17. The integrated digital factory and maintenance system of claim 11, wherein the processor-executable instructions, when executed by the one or more processors, cause the one or more maintenance analysis systems to provide visual representations of a plurality of maintenance locations of the maintenance shop via the graphical user interface.

18. The integrated digital factory and maintenance system of claim 11, wherein the data relating to the maintenance tasks for the wellsite equipment at the maintenance shop comprises data collected by global positioning system (GPS) tracking systems associated with respective wellsite equipment.

19. The integrated digital factory and maintenance system of claim 11, wherein the data relating to the maintenance tasks for the wellsite equipment at the maintenance shop comprises data collected by maintenance shop sensors located around the maintenance shop.

20. A method, comprising:
monitoring data relating to maintenance tasks for wellsite equipment at a maintenance shop in substantially real-time during performance of the maintenance tasks;
calculating a plurality of yield metrics, each yield metric of the plurality of yield metrics corresponding to respective maintenance stages of the maintenance tasks in substantially real-time during performance of the maintenance tasks;
calculating a predicted turnaround time for the maintenance tasks based on the plurality of yield metrics; and
providing the plurality of yield metrics and the predicted turnaround time for the maintenance tasks via a graphical user interface displayable via a display device.
